(19) United States
(12) Patent Application Publication
(10) Pub. No.: US 2023/0222478 A1
(43) Pub. Date: Jul. 13, 2023

(54) SELECTION OF A PAYMENT METHOD

(71) Applicant: VitraCash, Ltd., Ruislip (GB)

(72) Inventors: Koray KOSKA, London (GB); Florian WINKLER, London (GB)

(73) Assignee: VitraCash, Ltd., Ruislip (GB)

(21) Appl. No.: 17/575,603

(22) Filed: Jan. 13, 2022

(51) Int. Cl. G06Q 20/22; G06Q 20/40

(52) U.S. Cl. CPC G06Q 20/227; G06Q 20/40

(57) ABSTRACT

A method including receiving, at a processor, transaction data related to a payment transaction, the transaction data indicating payment information that is associated with multiple payment methods; determining, by the processor in real-time, a given payment method, from among the multiple payment methods, that is to be used to make a payment during the payment transaction; and transmitting, information associated with the given payment method to authorize use of the given payment method to make the payment. Various other aspects are contemplated.

### FIELD OF DISCLOSURE

The present disclosure generally relates to payment transactions, and more particularly to selection of a payment method from among a plurality of available payment methods.

### BACKGROUND

A payment method may be described as a way or a medium for paying value (e.g., money) during a payment transaction in exchange for goods and/or services. Popular payment methods include, for example, cash, checks, debit cards, credit cards, mobile payments, electronic banks transfers, automated clearing house (ACH) payments, wire transfers, stored value account payments, or the like. A given payment method may be used during the payment transaction to pay value for goods and/or services.

### SUMMARY

In one aspect, the present disclosure contemplates a method including receiving, at a processor, transaction data related to a payment transaction, the transaction data indicating payment information that is associated with multiple payment methods; determining, by the processor in real-time, a given payment method, from among the multiple payment methods, that is to be used to make a payment during the payment transaction; and transmitting, information associated with the given payment method to authorize use of the given payment method to make the payment.

In another aspect, the present disclosure contemplates a device associated with payment methods, the device comprising a memory and a processor communicatively coupled to the memory, the memory and the processor being configured to: receive transaction data related to a payment transaction, the transaction data indicating payment information that is associated with multiple payment methods; determine, in real-time, a given payment method, from among the multiple payment methods, that is to be used to make a payment during the payment transaction; and transmit information associated with the given payment method to authorize use of the given payment method to make the payment.

In another aspect, the present disclosure contemplates a non-transitory computer readable medium storing instructions, which when executed by a processor cause the processor to: receive transaction data related to a payment transaction, the transaction data indicating payment information that is associated with multiple payment methods; determine, in real-time, a given payment method, from among the multiple payment methods, that is to be used to make a payment during the payment transaction; and transmit information associated with the given payment method to authorize use of the given payment method to make the payment.

It is to be understood that both the foregoing general description and the following detailed description are exemplary and explanatory in nature and are intended to provide an understanding of the present disclosure without limiting the scope thereof. In that regard, additional aspects, features, and advantages of the present disclosure will be apparent to one skilled in the art from the following detailed description.

### BRIEF DESCRIPTION OF THE DRAWINGS

The accompanying drawings illustrate aspects of systems, devices, methods, and/or mediums disclosed herein and together with the description, serve to explain the principles of the present disclosure. Throughout this description, like elements, in whatever aspect described, refer to common elements wherever referred to and referenced by the same reference number. The characteristics, attributes, functions, interrelations ascribed to a particular element in one location apply to those elements when referred to by the same reference number in another location unless specifically stated otherwise.

The figures referenced below are drawn for ease of explanation of the basic teachings of the present disclosure; the extensions of the figures with respect to number, position, relationship, and dimensions of the parts to form the following aspects may be explained or may be within the skill of the art after the following description has been read and understood. Further, exact dimensions and dimensional proportions to conform to specific force, weight, strength, and similar requirements will likewise be within the skill of the art after the following description has been read and understood.

The following is a brief description of each figure used to describe the present disclosure, and thus, is being presented for illustrative purposes only and should not be limitative of the scope of the present disclosure.

FIG. 1 is an illustration of an example system associated with selection of a payment method, according to various aspects of the present disclosure.

FIG. 2 is an illustration of an example flow associated with selection of a payment method, according to various aspects of the present disclosure.

FIG. 3 is an illustration of examples associated with selection of a payment method, according to various aspects of the present disclosure.

FIG. 4 is an illustration of an example flow associated with selection of a payment method, according to various aspects of the present disclosure.

FIG. 5 is an illustration of an example process associated with selection of a payment method, according to various aspects of the present disclosure.

FIG. 6 is an illustration of example devices associated with selection of a payment method, according to various aspects of the present disclosure.

### DETAILED DESCRIPTION

For the purposes of promoting an understanding of the principles of the present disclosure, reference will now be made to the aspects illustrated in the drawings, and specific language may be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one aspect may be combined with the features, components, and/or steps described with respect to other aspects of the present disclosure. For the sake of brevity, however, the numerous iterations of these combinations may not be described separately. For simplicity, in some instances the same reference numbers are used throughout the drawings to refer to the same or like parts.

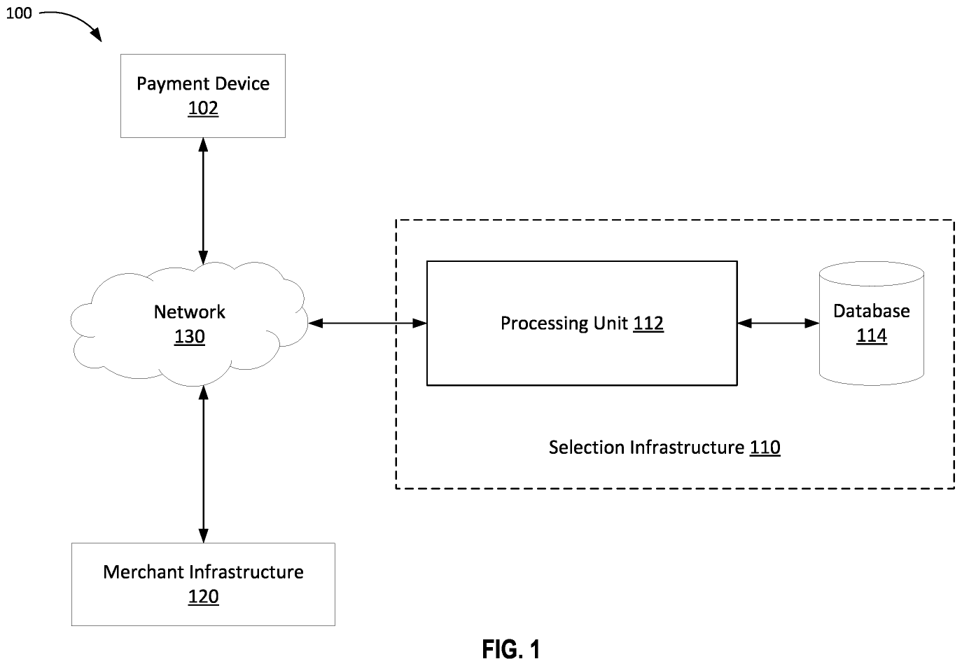

FIG. 1 is an illustration of an example system 100 associated with selection of a payment method, according to various aspects of the present disclosure. The system 100 includes a payment device 102, a selection infrastructure 110 including a processing unit 112 and a database (e.g., memory) 114, and a merchant infrastructure 120 communicating with one another over a network 130. The network 130 may be wired or wireless network. In some aspects, the network 130 may include one or more of, for example, a phone line, a near-field communication (NFC) network, a local-area network (LAN), a wide-area network (WAN), a metropolitan-area network (MAN), a home-area network (HAN), Internet, Intranet, Extranet, and Internetwork. In some aspects, the network 130 may include a digital telecommunication network that permits several nodes to share and access resources.

In some aspects, the payment device 102 may be associated with multiple payment methods. As a result, the multiple payment methods may be consolidated in the payment device 102. In an example, the payment device 102 may include a smart card, which may be a credit card associated with multiple payment methods (e.g., other credit cards, debit cards, bank accounts, or the like). For instance, payment information such as, for example, an account number, an expiration date, a card verification value (CVV) code, identification information of the user, or the like of the smart card (e.g., payment device 102) may be associated with similar information associated with the multiple payment methods. In another example, the payment device 102 may include a smart phone, a laptop computer, a desktop computer, a tablet computer, wearable smart devices such as, for example, a watch, a ring, a bracelet, or the like that stores the payment information (e.g., account number, an expiration date, a card verification value (CVV) code, and/or identification information) that is associated with multiple payment methods. In this way, the above examples of the payment device 102 may be associated with multiple payment methods (e.g., other credit cards, debit cards, bank accounts, or the like). The payment device 102 may include or be associated with a communication interface to communicate (e.g., transmit and/or receive) data. In some aspects, the payment device 102 may be referred to as a consolidated payment device based at least in part on being associated with the multiple payment methods.

The merchant infrastructure 120 may include or be associated with one or more merchant devices such as, for example, a point-of-sale (POS) system capable of accepting the multiple payment methods for processing of payment. The POS system may include firmware (e.g., hardware and/or software) to process the payment. In some aspects, the POS system may include a physical cash register. In some aspects, the POS system may be a digital merchant device system (e.g., online website, etc.) capable of accepting payment methods and processing payments over a network such as, for example, the Internet. The merchant infrastructure 120 may include or be associated with a communication interface to communicate (e.g., transmit and/or receive) data.

The selection infrastructure 110 may include the processing unit 112 and the database 114. The processing unit 112 may include a logical component configured to perform complex operations to evaluate various factors associated with selection of a given payment method from among the multiple payment methods. The database 114 may store various pieces of information associated with the various factors. During a given payment transaction, as discussed below in further detail, the processing unit 112 may access and evaluate, in real time, the various factors to select the given payment method. Further, the processing unit 112 may communicate with a financial institution associated with the given payment method to authorize using the given payment method to make the payment during the given payment transaction. The selection infrastructure 110 may include or be associated with a communication interface to communicate (e.g., transmit and/or receive) data in a secure and/or encrypted form.

As indicated above, FIG. 1 is provided as an example. Other examples may differ from what is described with regard to FIG. 1.

Multiple payment methods (e.g., multiple credit cards) may be available to a user. Each payment method may be associated with respective rewards and/or benefits when used to make payments during particular payment transactions. In an example, a first payment method may be associated with increased rewards and/or benefits when used to make a payment during a payment transaction at a gas station, a second payment method may be associated with increased rewards and/or benefits when used to make a payment during a payment transaction at a restaurant, and so on. The user may attempt to earn the increased rewards and/or benefits by selecting to use a given payment method, from among the multiple payment methods, to make the payment during a particular payment transaction.

The user may fail to earn the increased rewards and/or benefits because it may be difficult and confusing to track terms and conditions associated with the multiple payment methods. Each payment method may have several terms and conditions associated with using the payment method to earn the rewards and/or benefits. In an example, use of a given payment method to make the payment during a particular payment transaction may yield the increased rewards and/or benefits for only a given period of time (e.g., limited number of months), after an expiration of which, the increased rewards and/or benefits may not be earned. In another example, use of a given payment method to make the payment during a particular payment transaction may yield the increased rewards and/or benefits only after spending a certain amount of money. In yet another example, use of a given payment method to make payments during particular payment transactions may yield varying amounts (sometimes above a threshold amount and sometimes below the threshold amount) of rewards and/or benefits. In yet another example, use of a given payment method to make payments during particular payment transactions (e.g., foreign payment transactions) may result in increased fees compared to use of another payment method to make payments during the particular payment transactions. Moreover, the several terms and conditions may change over time or periodically. It may also be inconvenient to carry multiple payment methods at all times to have the multiple payment methods available for use. Additionally, the user may not have enough time during a payment transaction at a POS system to evaluate each payment method and determine which payment method is to be used to earn the increased rewards and/or benefits.

Various aspects of systems and techniques discussed in the present disclosure enable selection of a payment method from among a plurality of available payment methods. In some aspects, a selection infrastructure may store, for a registered user, an association of payment information and multiple payment methods. The selection infrastructure may provide the payment information to the registered user to be used to conduct a payment transaction (e.g., make payment during a payment transaction). In some aspects, the payment information may be included in a provided smart card (e.g., payment device), which the user may use to conduct the payment transaction. Additionally, the selection infrastructure may provide the payment information to be stored on a user device (e.g., payment device), which the user may use to conduct the payment transaction. When the user uses the payment information to conduct the payment transaction at a merchant infrastructure, the selection infrastructure receives encrypted transaction data from the merchant infrastructure. Based at least in part on the transaction data, the selection infrastructure automatically ranks and selects a given payment method, from among the multiple payment methods, to make the payment during the payment transaction. In some aspects, the selection infrastructure ranks and selects the given payment method in real time during the payment transaction. The selection infrastructure may automatically select the payment method that enables the user to earn increased rewards and/or benefits and, thereby, maximize value associated with using the multiple payment methods. While ranking and selecting the given payment method, the selection infrastructure may consider various factors including the payment device, the merchant infrastructure, monetary factors including a transaction cost, and/or non-monetary factors including predetermined preferences of the user. In some aspects, the selection infrastructure may obtain and store information regarding various terms and conditions associated with each of the multiple payment methods. Further, the selection infrastructure may update, in real-time and/or periodically, such stored information when terms and conditions change.

In this way, the selection infrastructure enables earning of increased rewards and/or benefits while avoiding the difficult and confusing task of tracking changing terms and conditions in real-time. Also, by enabling real-time ranking and selection of the given payment method, from among the multiple payment methods, the selection infrastructure enables the payment transaction to be completed timely, thereby enabling efficient use of resources. Further, the selection infrastructure enables to achieve the goal of earning increased rewards and/or benefits with higher accuracy by mitigating human error in calculating the rewards and/or benefits during the payment transaction, thereby improving the infrastructure devices. The selection infrastructure enables realization of increased aggregated rewards and/or benefits by performing the ranking and selection for all payment transactions, including payment transactions involving small sums of money for which a user may avoid to calculate the rewards and/or benefits. Provision of the payment information, associated with the multiple payment methods, avoidance inconvenience of carrying multiple payment methods at all times. Additionally, the selection infrastructure may utilize technical information to associate the payment information with a plurality of payment schemes (e.g., major credit cards, Apple pay, Google pay, Union pay, etc.), existing and to be developed in the future, to enable the payment information to be accepted globally.

In some aspects, a processor (e.g., processing unit 112) associated with the selection infrastructure may receive transaction data related to a payment transaction, the transaction data indicating payment information associated with multiple payment methods, and/or transmit, in real-time, information associated with a given payment method that is to be used during the payment transaction, the given payment method being from among the multiple payment methods.

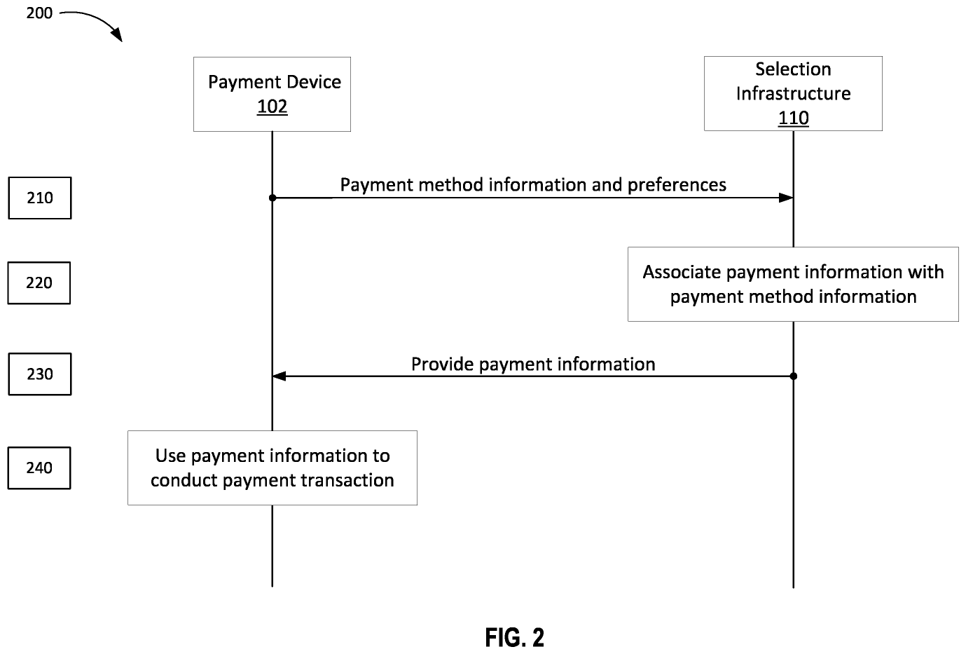

FIG. 2 is an illustration of an example flow 200 associated with selection of a payment method, according to various aspects of the present disclosure. In the example flow 200, a user device (e.g., payment device 102) may communicate with a selection infrastructure (e.g., selection infrastructure 110) over a network (e.g., network 130). In some aspects, the payment device 102 may communicate with the selection infrastructure 110 prior to conducting a payment transaction at a merchant infrastructure (e.g., merchant infrastructure 120). The payment device 102 and the selection infrastructure 110 may be associated with the respective communication interfaces to enable the payment device 102 and the selection infrastructure 110 to communicate with each other.

As shown by reference numeral 210, the payment device 102 may register with the selection infrastructure 110 to receive services. In some aspects, the payment device 102 may provide information associated with the payment device 102 including, for example, an identity of an owner of the payment device 102 and other information (e.g., address, contact information, or the like) associated with the owner of the payment device 102. The payment device 102 may also provide payment method information associated with N number of payment methods available to the owner, where N is an integer. In an example, when the multiple payment methods maybe credit cards, the payment method information may include information associated with each of the multiple credit cards such as, for example, a financial institution that issued the credit card, and account number associated with the credit card, an expiration date associated with the credit card, a CVV code associated with the credit card, a billing address associated with the credit card, or the like.

In some aspects, the payment device 102 may provide preferences (of the owner) that may affect selection of a given payment method from among the multiple payment methods. For instance, the payment device 102 may indicate that a particular payment method is to be used to make a payment during a particular payment transaction. In an example, the payment device 102 may indicate that a first payment method (e.g., Visa credit card) is to be used to make payments during payment transactions at gas stations, that a second payment method (e.g., American Express credit card) is to be used to make payments during payment transactions associated with airline travel, and so on. In some aspects, the payment device 102 may indicate that a particular payment method (e.g., MasterCard credit card) is to be used to make a payment during a payment transaction when a previously used payment method is declined or is unsuccessful.

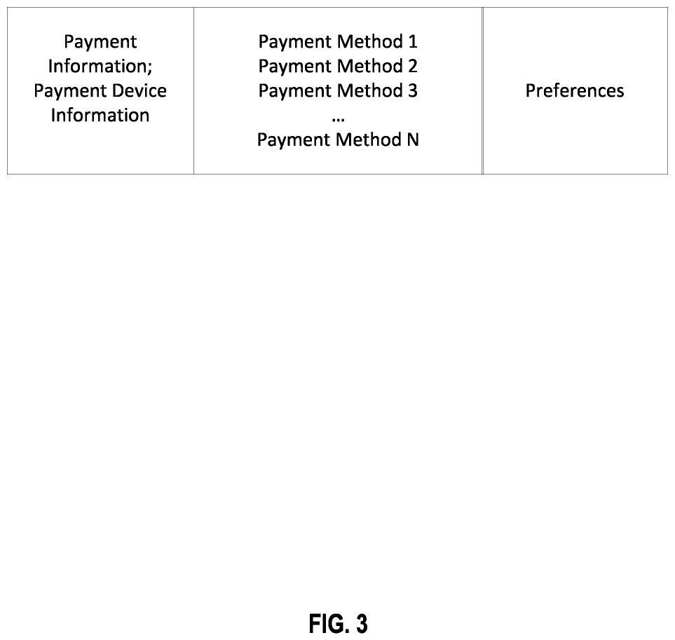

As shown by reference numeral 220, the selection infrastructure 110 may store information associated with the payment device 102, the payment method information associated with the payment device 102, and preferences provided by the payment device 102 in a database 114 associated with the selection infrastructure 110. Further, the selection infrastructure 110 may determine payment information to be used by the payment device 102 during a payment transaction. The payment information may be associated with the information associated with the payment device 102, the payment method information associated with the payment device 102, and preferences provided by the payment device 102 and the association may be stored in a correlated format. In some aspects, as shown in FIG. 3, the selection infrastructure 110 may store the association of the payment information, the information associated with the payment device 102, the payment method information associated with the payment device 102, and preferences provided by the payment device 102 in a correlated format. In this way, the selection infrastructure 110 may associate the payment device 102 with the multiple payment methods and the preferences. As discussed below, the correlated format may enable the selection infrastructure 110 to determine the multiple payment methods and the preferences associated with the payment device 102 during a payment transaction.

As shown by reference numeral 230, the selection infrastructure 110 may transmit the payment information, which is associated with the multiple payment methods, to the payment device 102. In some aspects, the payment information may be included in, for example, a provided smart card or may be transmitted to enable storage of the payment information in the payment device 102.

As shown by reference numeral 240, the payment device 102 may use the payment information to conduct a payment transaction. In some aspects, when the payment device 102 is a smart card, the payment device 102 may be used at a merchant infrastructure such as, for example, a POS system to conduct the payment transaction. In some aspects, the payment information may be provided to a digital merchant device system capable of accepting and processing payment information over a network such as, for example, the Internet.

As indicated above, FIGS. 2 and 3 is provided as an example. Other examples may differ from what is described with regard to FIGS. 2 and 3.

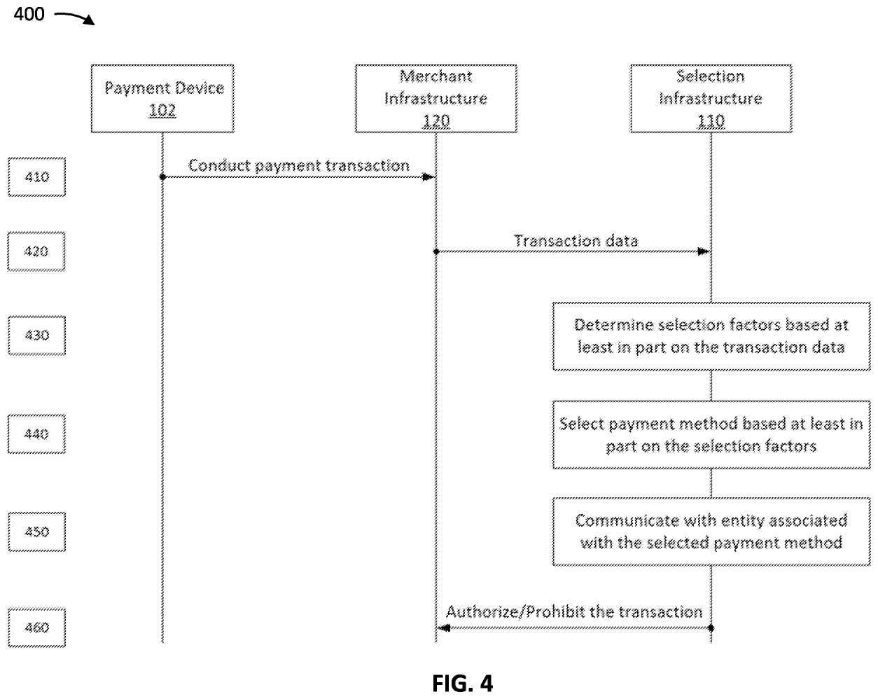

FIG. 4 is an illustration of an example flow 400 associated with selection of a payment method, according to various aspects of the present disclosure. In the example flow 400, a user device (e.g., payment device 102), a merchant infrastructure (e.g., merchant infrastructure 120), and a selection infrastructure (e.g., selection infrastructure 110) may communicate with each other over a network (e.g., network 130). The payment device 102, the merchant infrastructure 120, and the selection infrastructure 110 may be associated with the respective communication interfaces to enable the payment device 102, the merchant infrastructure 120, and the selection infrastructure 110 to communicate with each other.

As shown by reference numeral 410, the payment device 102 may use payment information to conduct a payment transaction at the merchant infrastructure 120. As discussed elsewhere herein, the payment device 102 may provide the payment information at a POS system or at a digital merchant device system associated with the merchant infrastructure 120.

As shown by reference numeral 420, based at least in part on receiving the payment information from the payment device 102, the merchant infrastructure 120 may automatically transmit, and the selection infrastructure 110 may automatically receive, transaction data. In some aspects, the transaction data may include, for example, information associated with the payment device 102, the payment information, merchant information, an amount associated with the payment transaction, a currency in which the payment transaction is to be conducted, and/or the like. The merchant information may be utilized by the selection infrastructure 110 to determine whether one or more payment methods may enable earning of increased rewards and/or benefits. For instance, when the merchant information indicates that the merchant is associated with a given business (e.g., Nike, Starbucks, Apple, etc.), the selection infrastructure 110 may use the merchant information to determine whether terms and conditions associated with one or more payment methods may enable earning of increased rewards and/or benefits. In some aspects, the transaction data may be transmitted by the merchant infrastructure 120 and may be received by the selection infrastructure 110 without intervention by the payment device 102 and/or by the owner of the payment device 102.

As shown by reference numeral 430, based at least in part on receiving the transaction data, the selection infrastructure 110 may determine selection factors to be evaluated in ranking multiple payment methods associated with the payment device 102. To determine the selection factors, the selection infrastructure 110 may use the payment information included in the transaction data to determine the multiple payment methods that are available to make a payment and the preferences. For instance, the selection infrastructure 110 may match the received payment information with payment information stored in a correlated format in a database (e.g., database 114) to determine the multiple payment methods and the preferences associated with the payment information. The selection infrastructure 110 may also determine that the payment information is associated with the payment device 102.

Based at least in part on determining the multiple payment methods, the selection infrastructure 110 may determine current (e.g., real-time) terms and conditions associated with each of the multiple payment methods. In some aspects, the selection infrastructure 110 may obtain and store the current terms and conditions at the time of registration of the payment device 102 with the selection infrastructure 110. Further, the selection infrastructure 110 may continuously update the stored terms and conditions as the terms and conditions change. Furthermore, the selection infrastructure 110 may obtain the terms and conditions in real-time during the payment transaction based at least in part on receiving the payment information. The terms and conditions associated with a payment method may include monetary terms such as, for example, a total cashback amount (e.g., 0.5%, 1%, 2%, 5%, or the like), fees charged for conducting this payment transaction, an amount of insurance provided for conducting this payment transaction, loyalty points provided for conducted this payment transaction, and/or the like.

Based at least in part on determining the current terms and conditions for each of the multiple payment methods, the selection infrastructure 110 may consider monetary factors. For instance, the selection infrastructure 110 may calculate respective total transaction costs for conducting this payment transaction associated with each of the multiple payment methods. For instance, for each payment method, the selection infrastructure 110 may calculate a respective total transaction cost by accounting for the respective total cashback amount (or other monetary benefits) to be received for conducting this payment transaction, respective total fees charged for conducting this payment transaction, and/or the like. In some aspects, to calculate the respective total transaction cost, the selection infrastructure 110 may deduct the respective total fees charged from the respective total cashback amount to be received. The selection infrastructure 110 may compare the calculated respective total transaction costs to rank the multiple payment methods. In an example, the selection infrastructure 110 may determine the payment method that provides the highest rewards and/or benefits for conducting this payment transaction, the payment method that provides the second highest rewards and/or benefits for conducting this payment transaction, and so on.

The selection infrastructure 110 may also dynamically obtain and consider monetary information based at least in part on determining a type associated with this payment transaction. For instance, when this payment transaction is a foreign transaction involving foreign currency, for each of the multiple payment methods, the selection infrastructure 110 may dynamically obtain and consider respective foreign exchange rate information. Further, for each of the multiple payment methods, the selection infrastructure may dynamically obtain respective fees associated with processing the foreign transaction, the fees being dependent on an amount associated with the foreign transaction and/or on whether the transaction is taking place during business hours (e.g., whether the market is open for business or closed for business). The selection infrastructure 110 may compare the respective foreign exchange rates and/or fees to rank the multiple payment methods. In an example, the selection infrastructure 110 may determine the payment method that provides the highest rewards and/or benefits for conducting this payment transaction, the payment method that provides the second highest rewards and/or benefits for conducting this payment transaction, and so on.

Further, the selection infrastructure 110 may consider non-monetary factors. In an example, the selection infrastructure 110 may consider the preferences stored in the database 114. In some aspects, the selection infrastructure 110 may determine whether the preferences indicate that a particular payment method is to be used for conducting this payment transaction. In an example, the preferences may indicate that a particular payment method is to be used to make a payment during a particular payment transaction. In this case, the selection infrastructure 110 may determine whether this payment transaction qualifies as the particular payment transaction. When this payment transaction qualifies as a particular payment transaction, the selection infrastructure 110 may consider making a payment during this transaction with the indicated particular payment method.

In another example, the selection infrastructure 110 may determine, for each of the multiple payment methods, a respective value associated with a total amount of insurance provided for conducting this payment transaction, a respective value associated with a number of loyalty points provided for conducting this payment transaction, and/or the like. The selection infrastructure 110 may compare the determined respective values to determine the payment method that provides the highest rewards and/or benefits for conducting this payment transaction, the payment method that provides the second highest rewards and/or benefits for conducting this payment transaction, and so on.

In yet another example, the selection infrastructure 110 may take into account past behavior of the payment device 102 associated with use of payment methods. For instance, the selection infrastructure 110 may give higher preference to a payment method that the payment device 102 has previously used for this type of payment transaction. Additionally, the selection infrastructure 110 may obtain data (e.g., from database 114) associated with other registered users and may give a higher preference to a payment method that is similar to a payment method that other registered users have preferred to use over a given period of time (e.g., last week, last month, etc.) for this type of payment transaction.

Based at least in part on considering the monetary factors and the non-monetary factors, as shown by reference numeral 440, the selection infrastructure 110 may select, in real-time, a given payment method, from among the multiple payment methods, to make the payment during this payment transaction. In some aspects, the given payment method may enable earning of increased rewards and/or benefits. In some aspects, the selection infrastructure 110 may give a higher preference to monetary factors over the non-monetary factors. In some aspects, the selection infrastructure 110 may give a higher preference to the non-monetary factors over the monetary factors.

As shown by reference numeral 450, based at least in part on selecting the given payment method, the selection infrastructure 110 may communicate with a financial institution (e.g., bank) associated with the given payment method. For instance, the selection infrastructure 110 may provide a bank that issued the given payment method (e.g., Visa credit card) with at least a portion of the transaction data to obtain authorization to use the given payment method to make the payment during this payment transaction. In response, the selection infrastructure 110 may receive authorization to use the given payment method to make the payment during this payment transaction. Based at least in part on receiving the authorization, as shown by reference numeral 460, the selection infrastructure 110 may authorize the merchant infrastructure 120 to complete this payment transaction using the given payment method. In response, the merchant infrastructure 120 may use the given payment method to make the payment during this payment transaction. In some aspects, the authorization may be transmitted by the selection infrastructure 110 and may be received by the merchant infrastructure 120 without intervention by a user and/or the payment device 120.

Alternatively, the selection infrastructure 110 may receive a prohibition from using the first payment method to make the payment during this payment transaction. In this case, the selection infrastructure 110 may select another payment method (e.g., the payment method that provides the second highest rewards and/or benefits for conducting this payment transaction) to make the payment during this payment transaction. Further, the selection infrastructure 110 may provide a bank that issued the other payment method (e.g., Discover credit card) with at least a portion of the transaction data to obtain authorization to use the other payment method to make the payment during this payment transaction. In response, the selection infrastructure 110 may receive authorization to use the other payment method to make the payment during this payment transaction. Based at least in part on receiving the authorization, as shown by reference numeral 460, the selection infrastructure 110 may authorize the merchant infrastructure 120 to complete this payment transaction using the other payment method. Alternatively, if the selection infrastructure 110 received another prohibition from using the other payment method to make the payment during this payment transaction, the selection infrastructure 110 may select a next payment method (e.g., MasterCard credit card) to make the payment during this payment transaction.

In a situation where all payment methods are prohibited from being used to make the payment during this payment transaction, the selection infrastructure 110 may transmit a prohibition to the merchant infrastructure 120 prohibiting this payment transaction from being completed. In this case, the merchant infrastructure 120 may cancel this payment transaction. In some aspects, the prohibition may be transmitted by the selection infrastructure 110 and may be received by the merchant infrastructure 120 without intervention by a user and/or the payment device 120.

As indicated above, FIG. 4 is provided as an example. Other examples may differ from what is described with regard to FIG. 4.

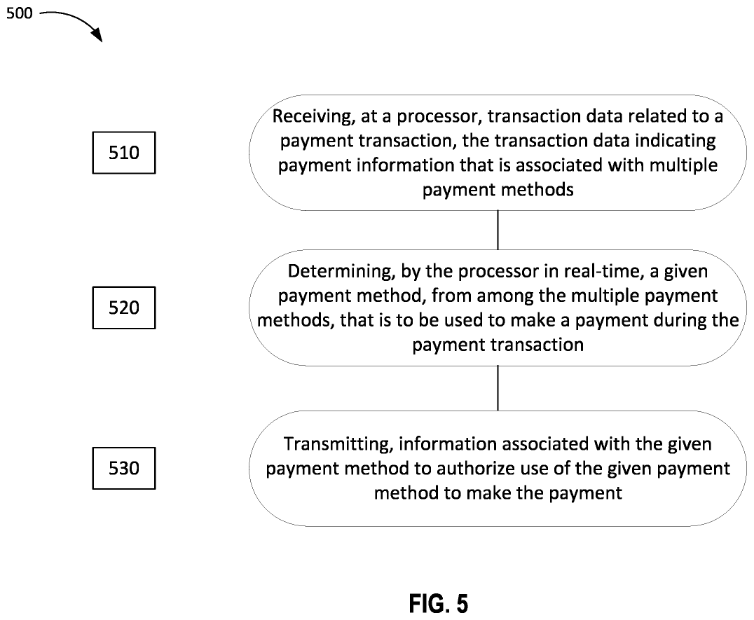

FIG. 5 is an illustration of an example process 500 associated with selection of a payment method, according to various aspects of the present disclosure. In some aspects, the process 500 may be performed by a processor/controller (e.g., processing unit 112 and/or processor 620) associated with a selection infrastructure (e.g., selection infrastructure 110). As shown by reference numeral 510, process 500 includes receiving transaction data related to a payment transaction, the transaction data indicating payment information that is associated with multiple payment methods. For instance, the selection infrastructure may utilize an associated communication interface (e.g., communication interface 670) along with the associated processor/controller to receive transaction data related to a payment transaction, the transaction data indicating payment information that is associated with multiple payment methods, as discussed elsewhere herein.

As shown by reference numeral 520, process 500 includes determining, by the processor in real-time, a given payment method, from among the multiple payment methods, that is to be used to make a payment during the payment transaction. For instance, the selection infrastructure may utilize the associated processor/controller to determine, in real-time, a given payment method, from among the multiple payment methods, that is to be used to make a payment during the payment transaction, as discussed elsewhere herein.

As shown by reference numeral 530, process 500 includes transmitting, information associated with the given payment method to authorize use of the given payment method to make the payment. For instance, the selection infrastructure may utilize the communication interface and the associated processor/controller to transmit information associated with the given payment method to authorize use of the given payment method to make the payment, as discussed elsewhere herein.

Process 500 may include additional aspects, such as any single aspect or any combination of aspects described below and/or in connection with one or more other processes described elsewhere herein.

In a first aspect, process 500 may include storing, in a database, an association of the payment information and the multiple payment methods.

In a second aspect, alone or in combination with the first aspect, process 500 includes determining the given payment method based at least in part on the payment information.

In a third aspect, alone or in combination with the first through second aspects, process 500 includes determining the given payment method based at least in part on the payment information, merchant information, and a user preference.

In a fourth aspect, alone or in combination with the first through third aspects, process 500 includes transmitting at least a portion of the transaction data to a financial institution associated with the given payment method to receive authorization to use the given payment method to make the payment; and receiving authorization from the financial institution to use the given payment method to make the payment.

In a fifth aspect, alone or in combination with the first through fourth aspects, in process 500, receiving the transaction data includes receiving the transaction data from a merchant device without user intervention; and transmitting the information associated with the given payment method includes transmitting the information associated with the given payment method to the merchant device without user intervention.

In a sixth aspect, alone or in combination with the first through fifth aspects, in process 500, determining the given payment method includes evaluating monetary and non-monetary factors associated with each of the multiple payment methods.

Although FIG. 5 shows example blocks of the process, in some aspects, the process may include additional blocks, fewer blocks, different blocks, or differently arranged blocks than those depicted in FIG. 5. Additionally, or alternatively, two or more of the blocks of the process may be performed in parallel.

As indicated above, FIG. 5 is provided as an example. Other examples may differ from what is described with regard to FIG. 5.

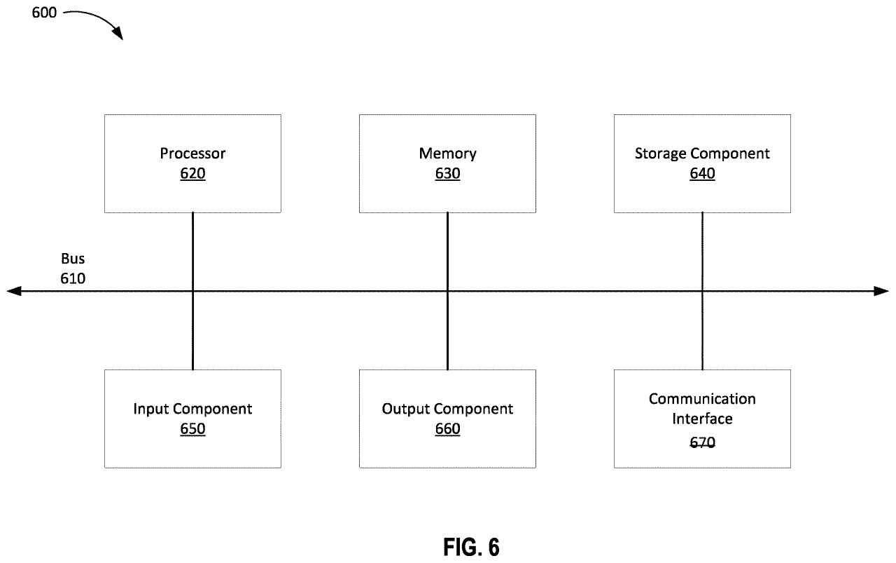

FIG. 6 is an illustration of example devices 600, according to various aspects of the present disclosure. In some aspects, the example devices 600 may form part of or implement the systems, environments, infrastructures, devices, components, or the like described elsewhere herein (e.g., FIG. 1 and/or FIG. 2) and may be used to perform the processes described with respect to FIG. 5. The example devices 600 may include a universal bus 610 communicatively coupling a processor 620, a memory 630, a storage component 640, an input component 650, an output component 660, and a communication interface 670.

Bus 610 may include a component that permits communication among multiple components of a device 600. Processor 620 may be implemented in hardware, firmware, and/or a combination of hardware and software. Processor 620 may take the form of a central processing unit (CPU), a graphics processing unit (GPU), an accelerated processing unit (APU), a microprocessor, a microcontroller, a digital signal processor (DSP), a field-programmable gate array (FPGA), an integrated circuit (e.g., ASIC, EMV, ASSP, SoC-ASSP, etc.), or another type of processing component. In some aspects, processor 620 may include one or more processors capable of being programmed to perform a function. Memory 630 may include a random access memory (RAM), a read only memory (ROM), and/or another type of dynamic or static storage device (e.g., a flash memory, a magnetic memory, and/or an optical memory) that stores information and/or instructions for use by processor 620.

Storage component 640 may store information and/or software related to the operation and use of a device 600. For example, storage component 640 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 650 may include a component that permits a device 600 to receive information, such as via user input (e.g., a touch screen display, a keyboard, a keypad, a mouse, a button, a switch, and/or a microphone). Additionally, or alternatively, input component 650 may include a component for determining location (e.g., a global positioning system (GPS) component) and/or a sensor (e.g., an accelerometer, a gyroscope, an actuator, another type of positional or environmental sensor, and/or the like). Output component 660 may include a component that provides output information from device 600 (via, for example, a display, a speaker, a haptic feedback component, an audio or visual indicator, and/or the like).

Communication interface 670 may include a transceiver-like component (e.g., a transceiver, a separate receiver, a separate transmitter, and/or the like) that enables a device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, and/or the like.

A device 600 may perform one or more processes described elsewhere herein. A device 600 may perform these processes based on processor 620 executing software instructions stored by a non-transitory computer-readable medium, such as memory 630 and/or storage component 640. As used herein, the term “computer-readable medium” may refer to a non-transitory memory device. A memory device may include memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described elsewhere herein. Additionally, or alternatively, hardware circuitry may be used in place of or in combination with software instructions to perform one or more processes described elsewhere herein. Thus, implementations described herein are not limited to any specific combination of hardware circuitry and software.

The quantity and arrangement of components shown in FIG. 6 are provided as an example. In practice, a device 600 may include additional components, fewer components, different components, or differently arranged components than those shown in FIG. 6. Additionally, or alternatively, a set of components (e.g., one or more components) of a device 600 may perform one or more functions described as being performed by another set of components of a device 600.

As indicated above, FIG. 6 is provided as an example. Other examples may differ from what is described with regard to FIG. 6.

Persons of ordinary skill in the art will appreciate that the aspects encompassed by the present disclosure are not limited to the particular exemplary aspects described herein. In that regard, although illustrative aspects have been shown and described, a wide range of modification, change, and substitution is contemplated in the foregoing disclosure. It is understood that such variations may be made to the aspects without departing from the scope of the present disclosure. Accordingly, it is appropriate that the appended claims be construed broadly and in a manner consistent with the present disclosure.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, or not equal to the threshold, among other examples, or combinations thereof.

It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, at a processor, transaction data related to a payment transaction, the transaction data indicating payment information that is associated with multiple payment methods;
determining, by the processor in real-time, a given payment method, from among the multiple payment methods, that is to be used to make a payment during the payment transaction; and
transmitting, by the processor, information associated with the given payment method to authorize use of the given payment method to make the payment.

2. The method of claim 1, further comprising:
storing, in a database, an association of the payment information and the multiple payment methods.

3. The method of claim 1, further comprising:
determining the given payment method based at least in part on the payment information.

4. The method of claim 1, further comprising:
determining the given payment method based at least in part on the payment information, merchant information, and a user preference.

5. The method of claim 1, further comprising:
transmitting at least a portion of the transaction data to a financial institution associated with the given payment method to receive authorization to use the given payment method to make the payment; and
receiving authorization from the financial institution to use the given payment method to make the payment.

6. The method of claim 1, wherein
receiving the transaction data includes receiving the transaction data from a merchant device without user intervention; and
transmitting the information associated with the given payment method includes transmitting the information associated with the given payment method to the merchant device without user intervention.

7. The method of claim 1, wherein determining the given payment method includes evaluating monetary and non-monetary factors associated with each of the multiple payment methods.

8. A device, comprising:
a memory; and
a processor communicatively coupled to the memory, the memory and the processor being configured to:
receive transaction data related to a payment transaction, the transaction data indicating payment information that is associated with multiple payment methods;
determine, in real-time, a given payment method, from among the multiple payment methods, that is to be used to make a payment during the payment transaction; and
transmit information associated with the given payment method to authorize use of the given payment method to make the payment.

9. The device of claim 8, wherein the memory and the processor being configured to:
store, in a database, an association of the payment information and the multiple payment methods.

10. The device of claim 8, wherein the memory and the processor being configured to:
determine the given payment method based at least in part on the payment information.

11. The device of claim 8, wherein the memory and the processor being configured to:
determine the given payment method based at least in part on the payment information, merchant information, and a user preference.

12. The device of claim 8, wherein the memory and the processor being configured to:
transmit at least a portion of the transaction data to a financial institution associated with the given payment method to receive authorization to use the given payment method to make the payment; and
receive authorization from the financial institution to use the given payment method to make the payment.

13. The device of claim 8, wherein
to receive the transaction data, the memory and the processor are configured to receive the transaction data from a merchant device without user intervention; and
to transmit the information associated with the given payment method, the memory and the processor are configured to transmit the information associated with the given payment method to the merchant device without user intervention.

14. The device of claim 8, wherein, to determine the given payment method, the memory and the processor are configured to evaluate monetary and non-monetary factors associated with each of the multiple payment methods.

15. A non-transitory computer-readable medium configured to store instructions, which when executed by a processor associated with a device, cause the processor to:
receive transaction data related to a payment transaction, the transaction data indicating payment information that is associated with multiple payment methods;
determine, in real-time, a given payment method, from among the multiple payment methods, that is to be used to make a payment during the payment transaction; and
transmit information associated with the given payment method to authorize use of the given payment method to make the payment.

16. The non-transitory computer-readable medium of claim 15, wherein the processor is configured to:
store, in a database, an association of the payment information and the multiple payment methods.

17. The non-transitory computer-readable medium of claim 15, wherein the processor is configured to:
determine the given payment method based at least in part on the payment information.

18. The non-transitory computer-readable medium of claim 15, wherein the processor is configured to:
determine the given payment method based at least in part on the payment information, merchant information, and a user preference.

19. The non-transitory computer-readable medium of claim 15, wherein the processor is configured to:
transmit at least a portion of the transaction data to a financial institution associated with the given payment method to receive authorization to use the given payment method to make the payment; and
receive authorization from the financial institution to use the given payment method to make the payment.

20. The non-transitory computer-readable medium of claim 15, wherein
to receive the transaction data, the processor is configured to receive the transaction data from a merchant device without user intervention; and
to transmit the information associated with the given payment method, the processor is configured to transmit the information associated with the given payment method to the merchant device without user intervention.
